(19) United States
(12) Patent Application Publication
(10) Pub. No.: US 2008/0201652 A1
(43) Pub. Date: Aug. 21, 2008

(54) Techniques for viewing and managing work items and their relationships

(75) Inventors: Moneta Ho, Seattle, WA (US); Vikram Bapat, Seattle, WA (US); Kaivalya Hanswadkar, Sammamish, WA (US); Jens Jacobsen, Seattle, WA (US); Lori Lamkin, Issaquah, WA (US); Chris Lucas, Sammamish, WA (US); Siddharth Bhatia, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/706,615

(22) Filed: Feb. 15, 2007

(51) Int. Cl. G06F 3/048

(52) U.S. Cl. 715/765; 715/804

(57) ABSTRACT

Various technologies and techniques are disclosed for viewing and managing work items. A work item management application is provided to allow a user to view and manage a plurality of work items from a single view. An interactive viewing feature is provided to allow the user to interactively view complex relationships between selected groups of work items. When the user selects all of the work items of a particular type in a work item group, the orphaned items are visually indicated. A many-to-many linker feature allows the user to create many-to-many relationships between a selected group of the work items in a single operation.

### BACKGROUND

In order to create computer software, developers must identify the features of the software, and then write the source code to implement the desired features. As part of the software development process, these system requirements lead to tasks that must be performed, which lead to qualities of service, which on completion may lead to associated defects. These and other related tasks can be tracked in items called work items.

Current development environments that allow a user to manage such work items suffer from several limitations. For example, it is common for one or more work items to be related to another, such as a system requirement that is related to an associated defect. In order to create a link between these work items, many of such systems require the user to add the link one link at a time, sometimes even using one or more separate dialogs. This can be very tedious when multiple work items need linked, and can be especially tedious when there are multiple work items that need to be linked to multiple other work items (e.g. many-to-many relationships).

Another limitation of current development environments is that they make it difficult to view complex relationships between work items, if they even support a feature to allow these complex relationships to be viewed.

### SUMMARY

Various technologies and techniques are disclosed for viewing and managing work items. A work item management application is provided to allow a user to view and manage a plurality of work items from a single view. An interactive viewing feature is provided to allow the user to interactively view complex relationships between selected groups of work items. In one implementation, direct and indirect relationships between the work items are visually indicated. A many-to-many link creation feature is provided that allows the user to create many-to-many relationships between a selected group of the work items in a single operation.

When the user selects all of the work items of a particular type in a work item group, the orphaned items are visually indicated. In one implementation, the orphaned items are visually indicated because they are the only work items in the group that are not shown with relationships to the other work items.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of work-item management application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the high-level stages involved in creating many-to-many relationships between work items.

FIG. 5 is a process flow diagram for one implementation of the system of FIG. 1 illustrating the more detailed stages involved in creating many-to-many relationships between work items.

FIG. 6 is a process flow diagram for one implementation of the system of FIG. 1 illustrating the stages involved in visually indicating orphaned work items.

FIG. 7 is a process flow diagram for one implementation of the system of FIG. 1 that illustrates the stages involved in creating and interacting with work item queries.

FIG. 8 is a process flow diagram for one implementation of the system of FIG. 1 that illustrates the stages involved in visually indicating various types of relationships between the work items.

FIG. 9 is a simulated screen for one implementation of the system of FIG. 1 that illustrates opening a saved work item query.

FIG. 10 is a simulated screen for one implementation of the system of FIG. 1 that illustrates selecting a work item query to use to populate a given column.

FIG. 11 is a simulated screen for one implementation of the system of FIG. 1 that displays relationships between work items across multiple column groupings of work items when the user selects work items from a first column grouping.

FIG. 12 is a simulated screen for one implementation of the system of FIG. 1 that displays both direct and indirect relationships for selected work items and also allows for creation of many-to-many relationships.

FIG. 13 is a simulated screen for one implementation of the system of FIG. 1 that visually indicates orphaned work items.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a software development application, but the system also serves other purposes in addition to these. In one implementation, one or more of the techniques described herein can be implemented as features within a software development program such as MICROSOFT® VISUAL STUDIO®, or from any other type of program or service that allows for viewing and management of software development-related work items. The term “work item” as used herein is meant to include work artifacts that include, but are not limited to test cases, bugs, requirements, risks, tasks and scenarios that are created during a software development process.

In one implementation, a work item management application is provided that allows a user to manage complex relationships between work items in a single view. The single view can display multiple columns that contain groups of different work items. The user can interactively view direct and indirect relationships between the work items, as well as other complex relationships. The user can assign many-to-many relationships to multiple work items in a single operation. Orphaned work items can be visually identified.

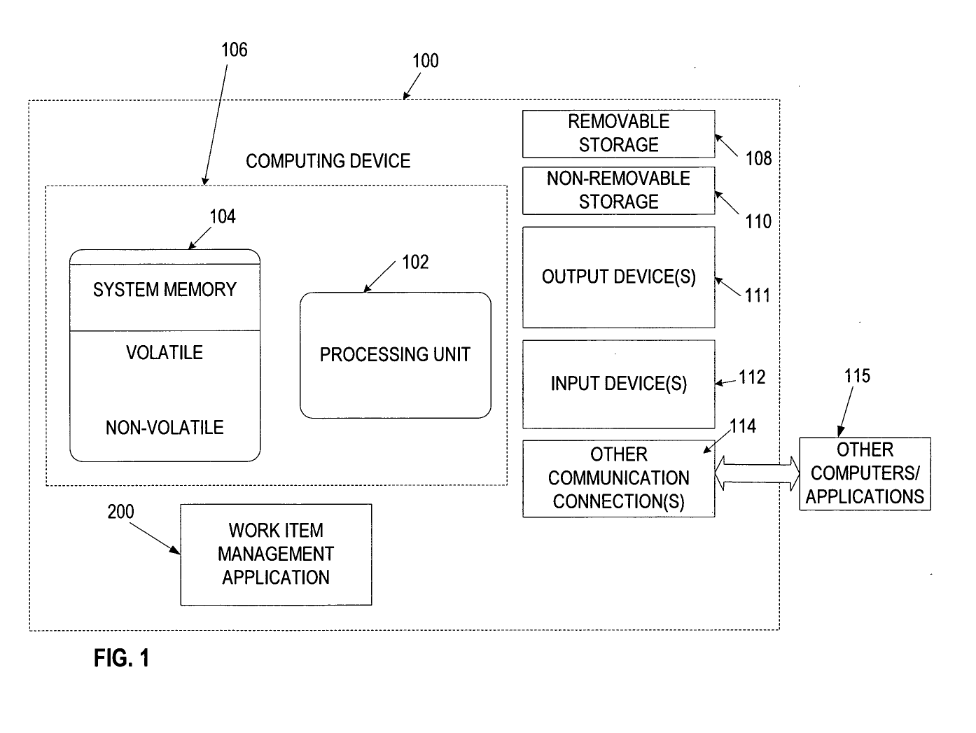

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

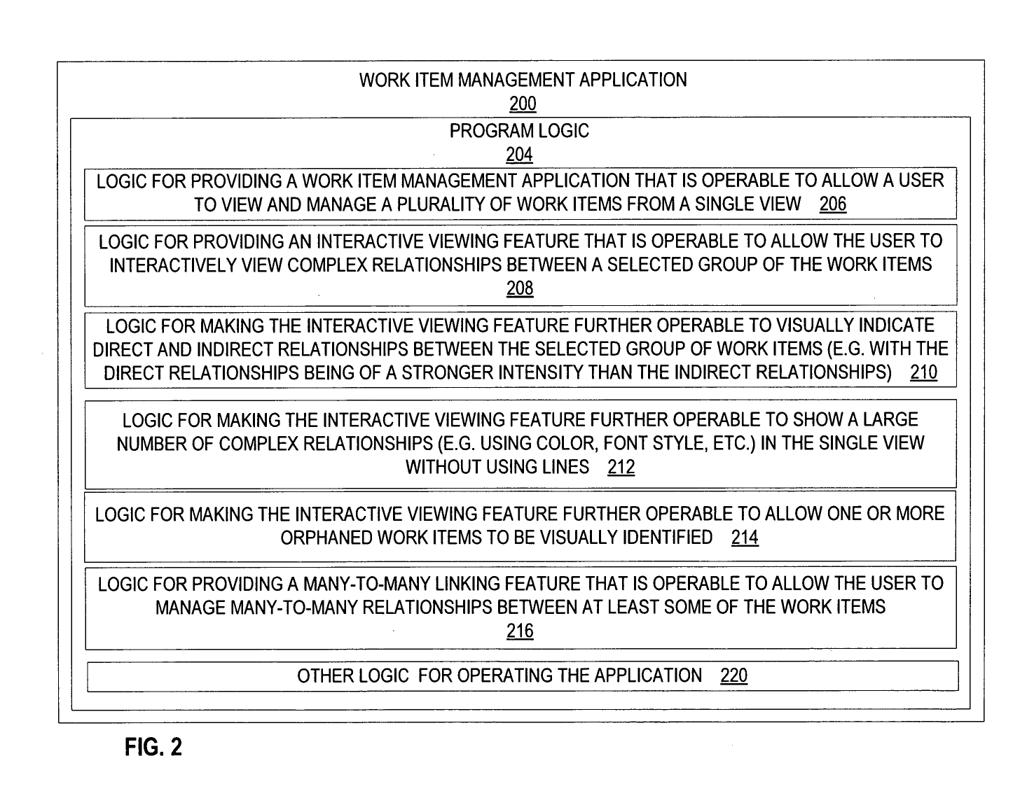

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes work item management application 200. Work item management application 200 will be described in further detail in FIG. 2.

Turning now to FIG. 2 with continued reference to FIG. 1, work item management application 200 operating on computing device 100 is illustrated. Work item management application 200 is one of the application programs that reside on computing device 100. However, it will be understood that work item management application 200 can alternatively or additionally be embodied as computer-executable instructions on one or more computers and/or in different variations than shown on FIG. 1. Alternatively or additionally, one or more parts of work item management application 200 can be part of system memory 104, on other computers and/or applications 115, or other such variations as would occur to one in the computer software art.

Work item management application 200 includes program logic 204, which is responsible for carrying out some or all of the techniques described herein. Program logic 204 includes logic for providing a work item management application that is operable to allow a user to view and manage a plurality of work items from a single view 206; logic for providing an interactive viewing feature that is operable to allow the user to interactively view complex relationships between a selected group of the work items 208; logic for making the interactive viewing feature further operable to visually indicate direct and indirect relationships between the selected group of work items (e.g. with the direct relationships being of a stronger intensity than the indirect relationships) 210; logic for making the interactive viewing feature further operable to show a large number of complex relationships (e.g. using color, font style, etc.) in the single view without using lines 212; logic for making the interactive viewing feature further operable to allow one or more orphaned work items to be visually identified 214; logic for providing a many-to-many linking feature that is operable to allow the user to manage many-to-many relationships between at least some of the work items 216; and other logic for operating the application 220. In one implementation, program logic 204 is operable to be called programmatically from another program, such as using a single call to a procedure in program logic 204.

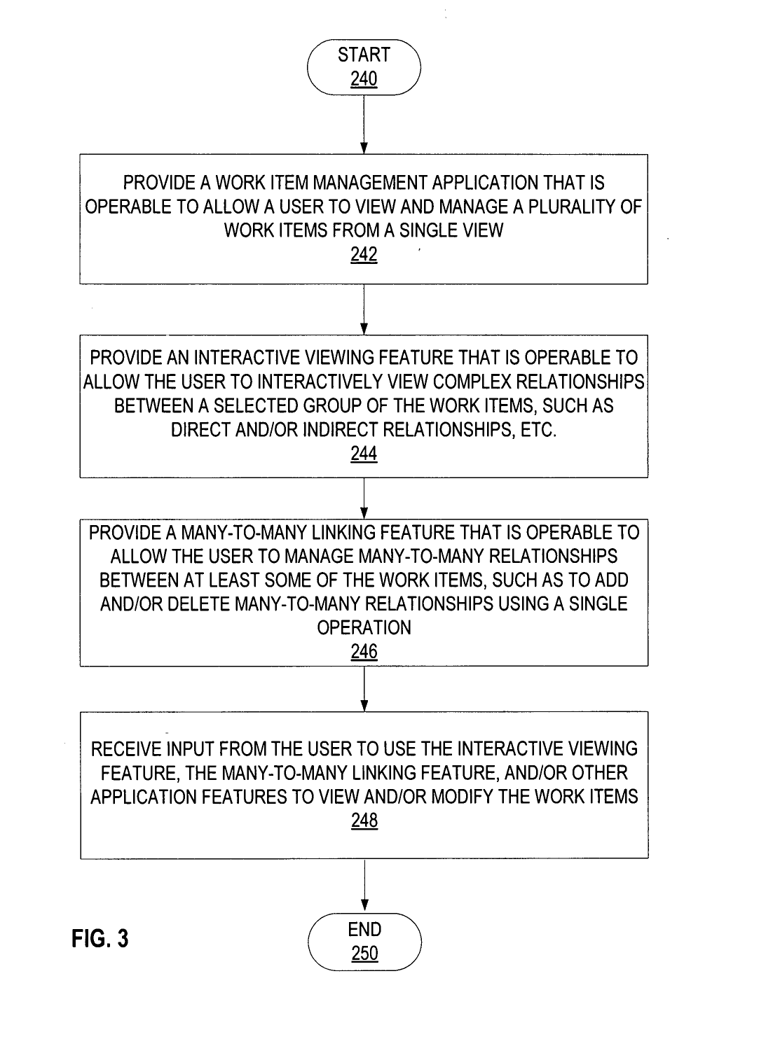

Turning now to FIGS. 3-8 with continued reference to FIGS. 1-2, the stages for implementing one or more implementations of work item management application 200 are described in further detail. FIG. 3 is a high level process flow diagram for work item management application 200. In one form, the process of FIG. 3 is at least partially implemented in the operating logic of computing device 100. The process begins at start point 240 with providing a work item management application that is operable to allow a user to view and manage a plurality of work items from a single view (stage 242). An interactive viewing feature is provided that is operable to allow the user to interactively view complex relationships between a selected group of the work items, such as direct and/or indirect relationships, etc. (stage 244). A many-to-many linking feature is provided that is operable to allow the user to manage many-to-many relationships between at least some of the work items, such as to add and/or delete many-to-many relationships using a single operation (stage 246). Other relationships (one-to-many, one-to-one, etc.) can also be managed using the work item management application. The user can use the interactive viewing feature, the many-to-many linking feature, and/or other application features to view and/or modify the work items (stage 248). The process ends at end point 250.

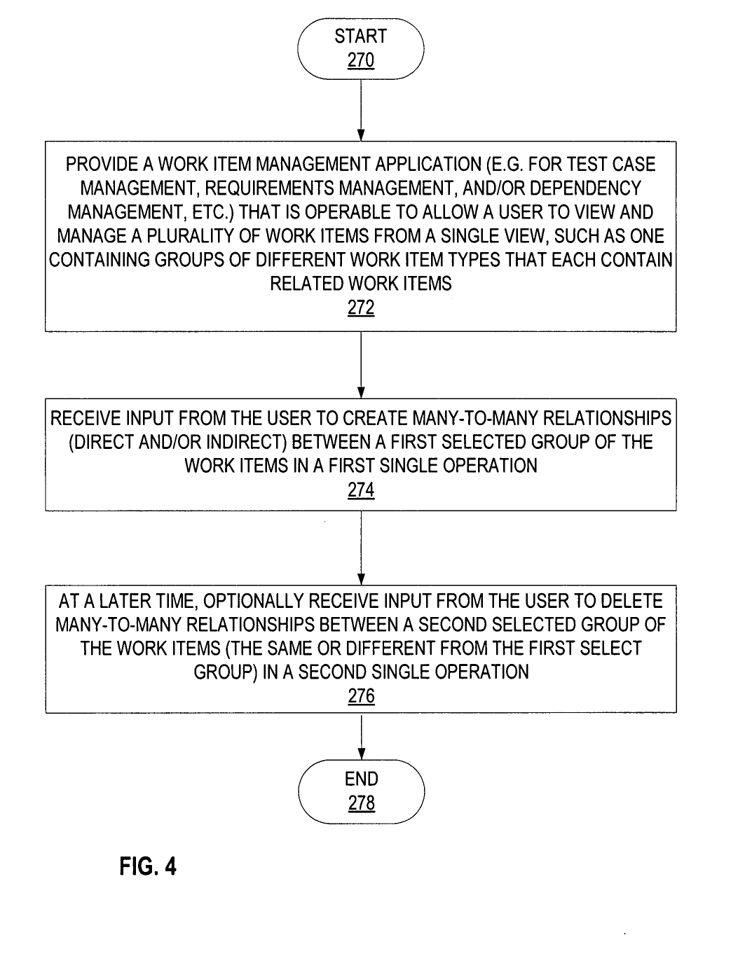

FIG. 4 illustrates one implementation of the high-level stages involved in creating many-to-many relationships between work items. In one form, the process of FIG. 4 is at least partially implemented in the operating logic of computing device 100. The process begins at start point 270 with providing a work item management application that is operable to allow a user to view and manage a plurality of work items from a single view, such as one containing groups of different work item types that each contain related work items (stage 272). In one implementation, the work item management application is used for test case management, requirements management, and/or dependency management, etc. (stage 272). Input is received from the user to create many-to-many relationships (direct and/or indirect) between a first selected group of the work items in a first single operation (stage 274). At a later point in time, input is optionally received from the user to delete many-to-many relationships between a second selected group of the work items (the same or different from the first selected group) in a second single operation (stage 276). The process ends at end point 278.

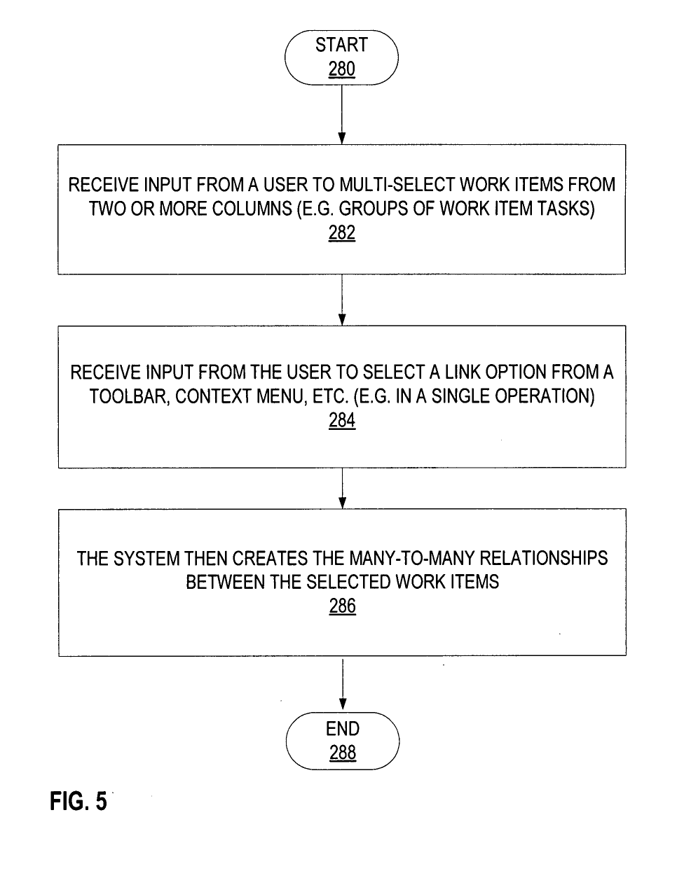

FIG. 5 illustrates one implementation of the more detailed stages involved in creating many-to-many relationships between work items. In one form, the process of FIG. 5 is at least partially implemented in the operating logic of computing device 100. The system begins at start point 280 with receiving input from a user to multi-select work items from two or more columns (e.g. groups of work item tasks) (stage 282). The system receives input from the user to select a link option from a toolbar menu, from a context menu, etc. (e.g. in a single operation) (stage 284). The system then creates the many-to-many relationships between the selected work items (stage 286). The process ends at end point 288.

In one implementation, to create one-to-many links, the user can multi-select a set of work items and drag them on top of the work item in the view that should be linked to all of them. Other variations are also possible for creating one-to-many links.

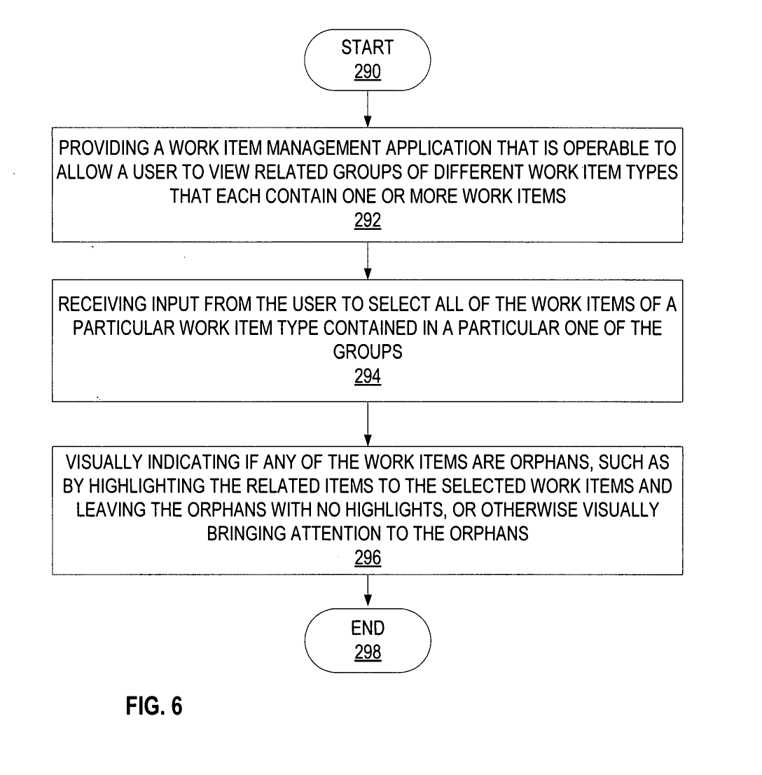

FIG. 6 illustrates one implementation of the stages involved in visually indicating orphaned work items. In one form, the process of FIG. 6 is at least partially implemented in the operating logic of computing device 100. The process begins at start point 290 with providing a work item management application that is operable to allow a user to view related groups of different work item types that each contain one or more work items (stage 292). Input is received from the user to select all of the work items of a particular work item type contained in a particular one of the groups (stage 294). The system visually indicates if any of the work items are orphans, such as by highlighting the related items to the selected work items and leaving the orphans with no highlights, or otherwise visually bringing attention to the orphans (stage 296). The process ends at end point 298.

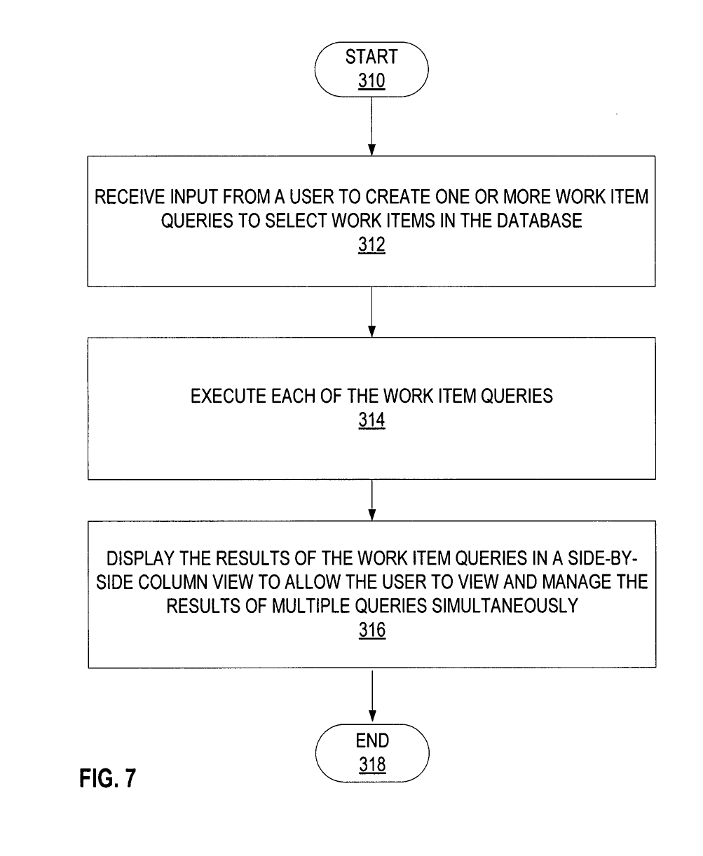

FIG. 7 illustrates one implementation of the stages involved in creating and interacting with work item queries. In one form, the process of FIG. 7 is at least partially implemented in the operating logic of computing device 100. The process begins at start point 310 with receiving input from a user to create one or more work item queries to select work items in the database (stage 312). The system executes each of the work item queries against the database (stage 314). The system then display the results of the work item queries in a side-by-side column view to allow the user to view and manage the results of multiple queries simultaneously (stage 316).

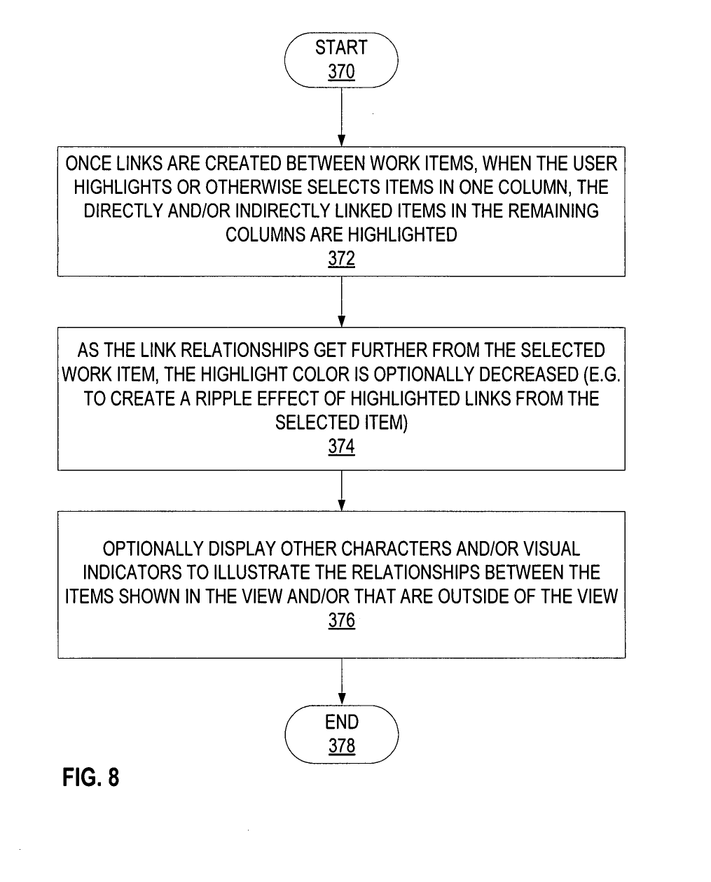

FIG. 8 illustrates one implementation of the stages involved in visually indicating various types of relationships between the work items. In one form, the process of FIG. 8 is at least partially implemented in the operating logic of computing device 100. The process begins at start point 370 with the user highlighting or otherwise selecting items in one column, so the directly and/or indirectly linked items in the remaining columns are visually highlighted (stage 372). As the link relationships get further from the selected work item, the highlight color is optionally decreased (e.g. to create a ripple effect of highlighted links from the selected item) (stage 374). The system optionally displays other characters and/or visual indicators to illustrate the relationships between the items shown in the view and/or that are outside of the view (stage 376). In one implementation, indicators are shown to indicate that certain relationships are present outside of the view. The process ends at end point 378.

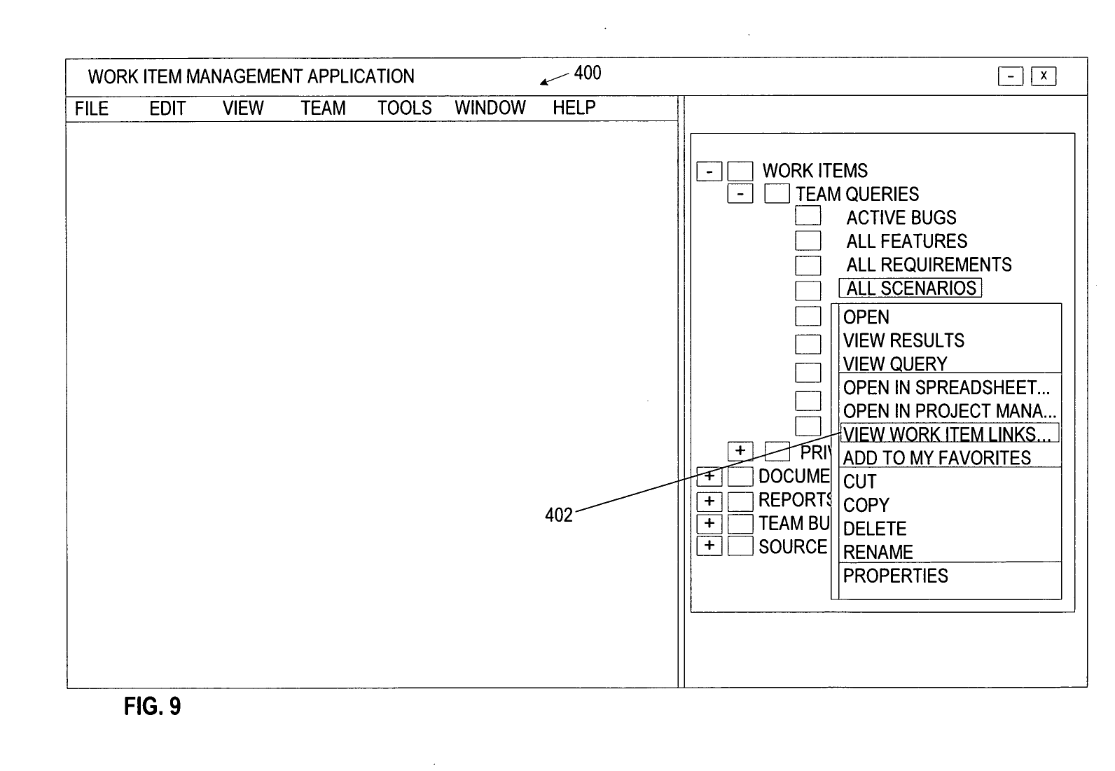

Turning now to FIGS. 9-13, simulated screens are shown to illustrate a user interface that allows viewing and management of work items using work item management application 200. These screens can be displayed to users on output device(s) 111. Furthermore, these screens can receive input from users from input device(s) 112.

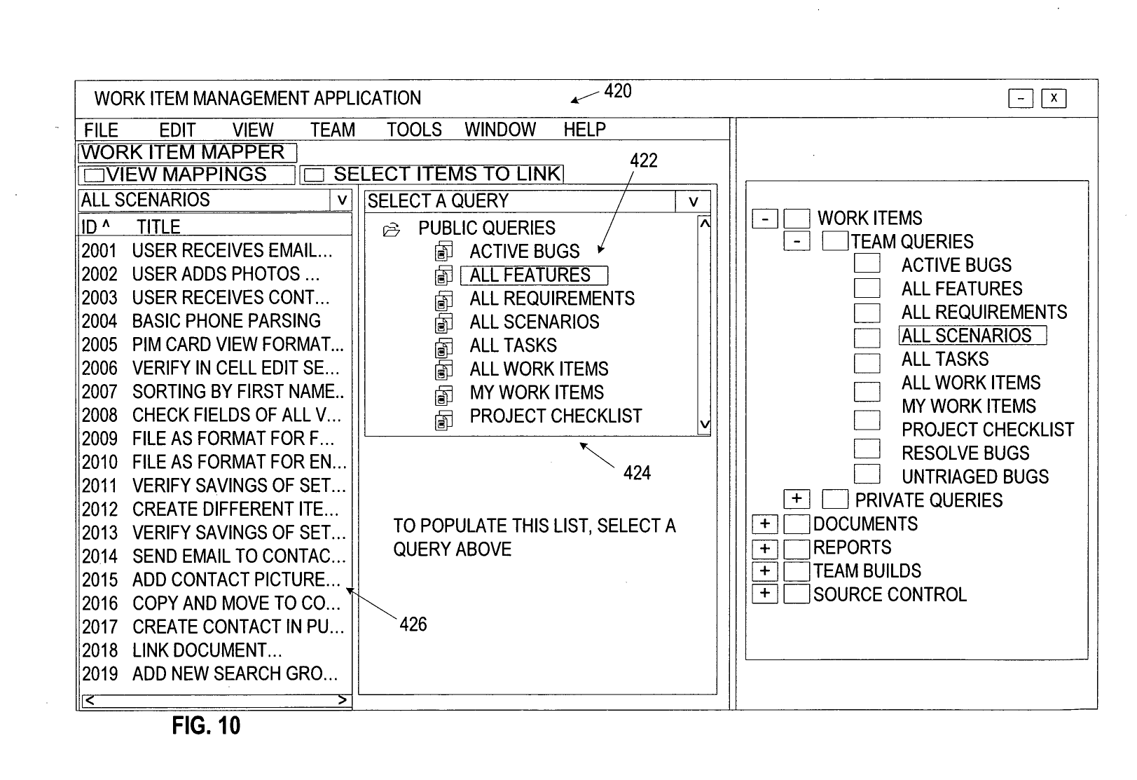

FIG. 9 is a simulated screen 400 for one implementation of the system of FIG. 1 that illustrates opening a saved work item query 402 from a work item menu. FIG. 10 is a simulated screen 420 that illustrates selecting a work item query 422 to use to populate a given column 424. The results of another work item query are displayed in a separate column 426.

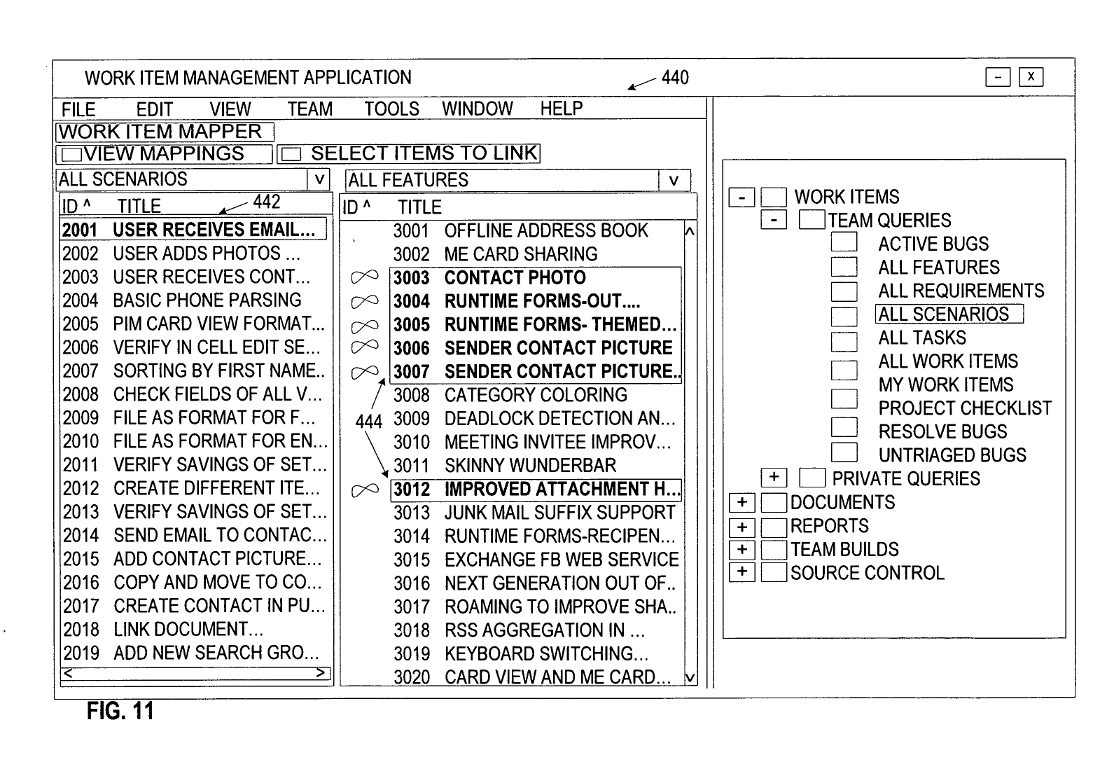

FIG. 11 is a simulated screen 440 that displays relationships between work items across multiple column groupings of work items when the user selects one or more work items from a first column grouping. In the example shown, when the work item 442 is selected in the first column grouping, the related work items 444 in the second column grouping is visually indicated.

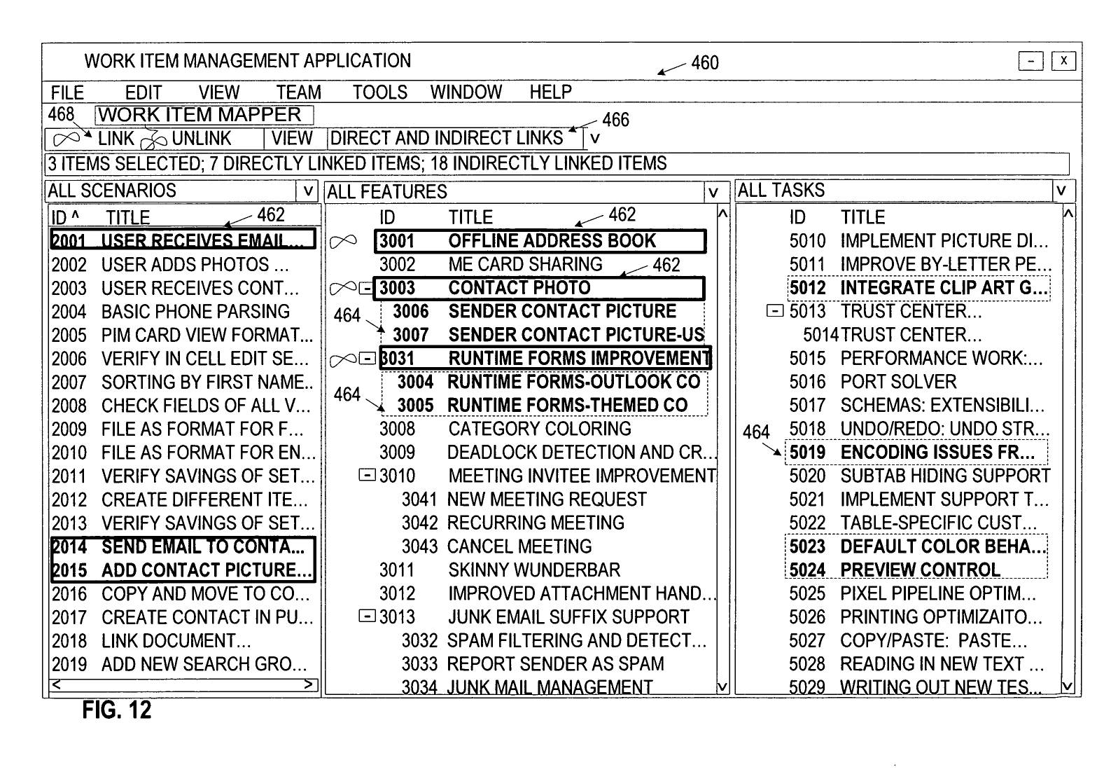

Turning now to FIG. 12, a simulated screen 460 for one implementation is shown that displays both direct and indirect relationships for selected work items and also allows for creation of many-to-many relationships. Direct relationships are indicated with a first type of visual indication 462, and indirect relationships are indicated with a second type of visual indication 464. The user can select an option 466 to indicate which types of relationships to display. The user can also select a link option 468 to create many-to-many relationships between the selected items using a single operation.

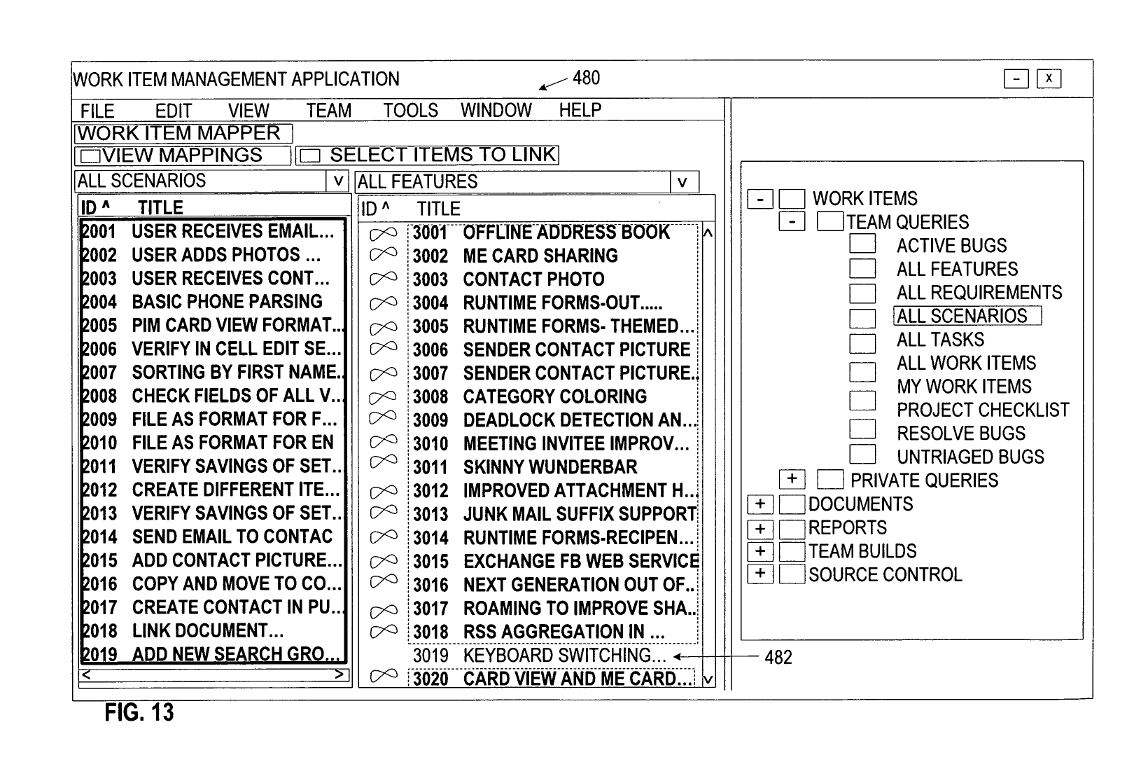

FIG. 13 is a simulated screen 480 for one implementation that visually indicates orphaned work items 482. In the example shown, there is one orphaned work item 482 that is not part of any of the highlighted relationships (i.e. is not being used or otherwise referenced). Because there is an absence of relationships indicated for that work item 482, the work item 482 stands out visually from the rest of the work items as being orphaned. In other implementations, the orphaned work item(s) can be visually indicated directly or indirectly in a different manner than shown on FIG. 13.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for quickly creating many-to-many relationships between a plurality of work items comprising the steps of:
providing a work item management application that is operable to allow a user to view and manage a plurality of work items from a single view; and
receiving input from the user to create many-to-many relationships between a first selected group of the work items in a first single operation.

2. The method of claim 1, wherein the single view contains groups of different work item types that each contain one or more related work items.

3. The method of claim 1, wherein the work items are related to test case management.

4. The method of claim 1, wherein the work items are related to requirements management.

5. The method of claim 1, wherein the work items are related to dependency management.

6. The method of claim 1, further comprising
receiving input from the user to delete many-to-many relationships between a second selected group of the work items in a second single operation.

7. The method of claim 6, wherein the first selected group and the second selected group are a same group.

8. The method of claim 1, wherein at least some of the first selected group of the work items have a direct relationship.

9. The method of claim 1, wherein at least some of the first selected group of the work items have an indirect relationship.

10. A computer-readable medium having computer-executable instructions for causing a computer to perform the steps recited in claim 1.

11. A computer-readable medium having computer-executable instructions for causing a computer to perform steps comprising:
provide a work item management application that is operable to allow a user to view and manage a plurality of work items from a single view; and
provide an interactive viewing feature that is operable to allow the user to interactively view complex relationships between a selected group of the work items.

12. The computer-readable medium of claim 11, wherein the interactive viewing feature is further operable to visually indicate direct and indirect relationships between the selected group of work items.

13. The computer-readable medium of claim 12, wherein the interactive viewing feature is further operable to visually indicate the direct relationships with a stronger intensity than the indirect relationships.

14. The computer-readable medium of claim 11, wherein the interactive viewing feature is further operable to show a large number of complex relationships in the single view without using lines.

15. The computer-readable medium of claim 14, wherein at least part of the complex relationships are shown using color.

16. The computer-readable medium of claim 14, wherein at least part of the complex relationships are shown using font characteristics.

17. The computer-readable medium of claim 11, wherein the interactive viewing feature is further operable to allow one or more orphaned work items to be visually identified.

18. The computer-readable medium of claim 11, further comprising:
provide a many-to-many linking feature that is operable to allow the user to manage many-to-many relationships between at least some of the work items.

19. A method for quickly identifying orphaned work items comprising the steps of:
providing a work item management application that is operable to allow a user to view related groups of different work item types that each contain one or more work items;
receiving input from the user to select all of the work items of a particular work item type contained in a particular one of the groups; and
visually indicating if any of the work items are orphans.

20. A computer-readable medium having computer-executable instructions for causing a computer to perform the steps recited in claim 19.
